(19) United States
(12) Patent Application Publication
(10) Pub. No.: US 2026/0222212 A1
(43) Pub. Date: Jul. 30, 2026

(54) SYSTEMS AND TECHNIQUES FOR MULTI-PARTY COMPUTATION (MPC) SIGNATURE WITH KEY CARDS AND MOBILE TERMINALS

(71) Applicant: NAGRAVISION SARL, CHESEAUX-SUR-LAUSANNE (CH)

(72) Inventor: Luc Devallonné, CHESEAUX-SUR-LAUSANNE (CH)

(73) Assignee: NAGRAVISION SARL, CHESEAUX-SUR-LAUSANNE (CH)

(21) Appl. No.: 19/146,650

(22) PCT Filed: Jan. 16, 2024
(86) PCT No.: PCT/IB2024/050419

§ 371 Date: Jul. 9, 2025

Related U.S. Application Data
(60) Provisional application No. 63/439,429, filed on Jan. 17, 2023.

(51) Int. Cl. H04L 9/32; H04L 9/00; H04L 9/30

(52) U.S. Cl. CPC H04L 9/3234; H04L 9/008; H04L 9/3073

(57) ABSTRACT

Aspects are described herein for providing access control based on key sections of a key of a key pair. For example, a computing device can receive, from at least two entities, at least two key sections associated with a first key of a key pair. The computing device can generate the first key of the key pair based on the at least two key sections. The computing device can further output the first key to provide access to a service.

### CROSS-REFERENCE TO RELATED APPLICATIONS

This application claims priority to U.S. Provisional Patent Application No. 63/439,429 filed Jan. 17, 2023, which is hereby incorporated by reference, in its entirety and for all purposes.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Certain aspects of the present disclosure are directed towards using multi-party computation (MPC) to implement access control. For example, multiple users with mobile devices and NFC cards may possess partial signatures (e.g., also referred to “key shares”) that may, together, be used to generate a key for access. The access may be used for any suitable application, such as providing access to a blockchain, providing an access authorization token, providing permissions data for granting permissions for one or more applications, services, or systems, and/or other application.

In some aspects, the partial signatures may be based on a private key of a key pair (e.g., including a public key and a private key). Public and private keys are an important part of cryptocurrencies as they allow sending and receiving of cryptocurrency without requiring a third party to verify the transactions. The public and private keys fit together as a key pair, where public keys may be shared to receive transactions, but private keys are kept secret (e.g., in a hardware wallet). Keeping the private key secret is important because if anyone has access to the private key, they will also have access to any cryptocurrency associated with the key.

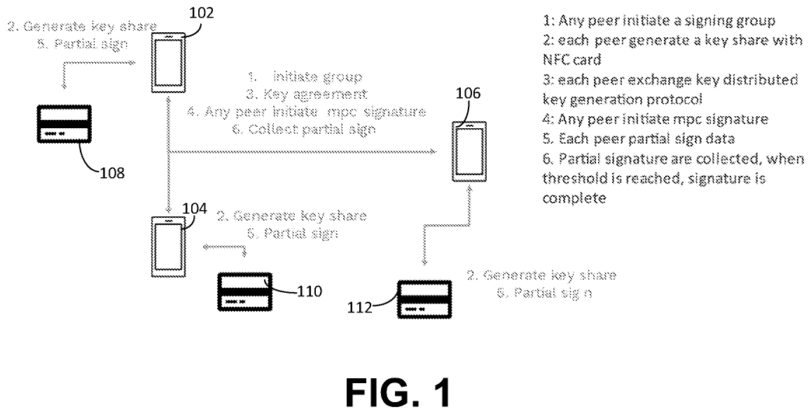

FIG. 1 is a block diagram illustrating example access control techniques using MPC, in accordance with certain aspects of the present disclosure. There may be multiple users, each having a mobile device and a key card (e.g., near-field communication (NFC) card). For instance, mobile device 102 and NFC card 108 may belong to a first user, mobile device 104 and NFC card 110 may belong to a second user, and mobile device 106 and NFC card 112 may belong to a third user.

In some aspects, an initial setup process may occur to create a group for providing access to a service. For example, a family may set up a group that together can provide access to a blockchain wallet, one or more applications, services, or systems (e.g., an access authorization token for accessing a vehicle system, a network such as a home network, etc.), etc. As an example, mobile device 102 may initiate (e.g., create) a signing group using an application (e.g., an applet) on the mobile device. Once the group is created, the NFC cards belonging to the users of the group may generate respective key shares. In some aspects, the generated key shares may be distributed via mobile devices to perform a key agreement. For instance, using a key generation protocol, a private key may be generated using the key shares that were separately generated by the NFC cards. The private key, along with its associated public key, may be used to secure access to an service, application, and/or system, such as a blockchain, a vehicle system, a network, etc.

To facilitate access to the service, application, and/or system, any user (e.g., using a mobile device) may initiate MPC signature. Each NFC card may then provide its partial signature (e.g., key share) to its respective mobile device. For example, NFC card 108 may provide a key share to mobile device 102, NFC card 110 may provide a key share to mobile device 104, and NFC card 112 may provide a key share to mobile device 106. The mobile devices act as proxies for sharing of secrets (e.g., key shares), while the cryptographic operations may be performed on the NFC cards (e.g., using a JavaCard). The key shares are then distributed across mobile devices until a quorum of signatures is reached for access. For instance, when a signature is necessary, an initiator (e.g., mobile device 102) crafts (e.g., receives from corresponding NFC card) the first partial signature, then it is handed from mobile device to mobile device (e.g., in a peer-to-peer manner or via email, messaging application or the cloud) until a quorum of signature is reached, at which point, the signature result (e.g., the private key) may be submitted for access.

In some aspects, the resulting signature (e.g., private key) may be used for an elliptic curve digital signature algorithm (ECDSA) based process. The signature may be used for blockchain transaction signing (e.g., fund transfer, contract management, or non-fungible token (NFT)), an access authorization token (e.g., for accessing the service, application, and/or system), permissions for accessing the service, application, and/or system, etc. The signature may be used for fast identity online (FIDO) like authentication, thus bringing a cryptographically enforced multi-factor authentication. In some examples, the signature may be used for blockchain smart contract management. In some aspects, the access system described herein may be enhanced using cloud based signing parties to, for example, support central revocation. In some aspects, the mobile device's version (e.g., to implement the access system described herein) may be implemented in software only. The key card (e.g., NFC card) may be implemented with Bluetooth low energy (BLE) to ease the connection process (e.g., for key distribution/access).

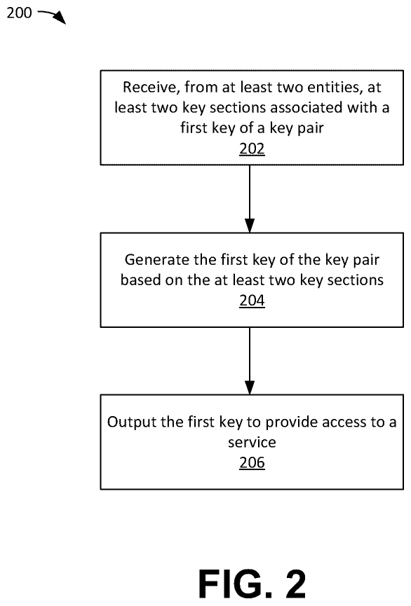

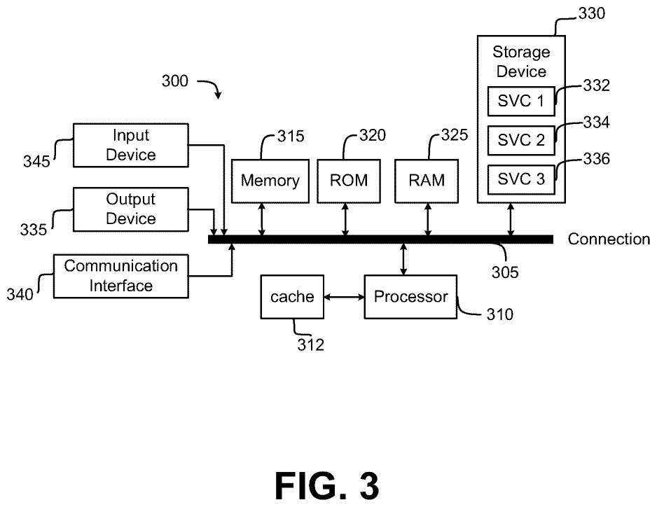

FIG. 2 illustrates example operations 200 for access rights transfer, in accordance with certain aspects of the present disclosure. Operations 200 may be performed by a computing system, such as the mobile device 102 described with respect to FIG. 2 or computing system 300 described with respect to FIG. 3.

At block 202, the computing system receives, from at least two entities, at least two key sections (e.g., key shares) associated with a first key (e.g., a private key) of a key pair. In some aspects, the at least two key sections are generated via at least two key cards, respectively. The at least two key cards may include at least two NFC cards.

In some aspects, the computing system may generate, using an application on a mobile device, a group including the at least two entities. The at least two key sections may be generated in response to the group being generated.

At block 204, the computing system generates the first key of the key pair based on the at least two key sections. At block 206, the computing system outputs the first key to provide access to a service. In some aspects, the first key is used to provide access for a blockchain, for an access authorization token (e.g., for accessing the service, application, and/or system), for permissions for accessing the service, application, and/or system, etc.

In some aspects, a first key section of the at least two key sections may be received from a first entity of the at least two entities, and a second key section of the at least two key sections may be received (e.g., indirectly) from a second entity of the at least two entities through the first entity.

In some aspects, the first key is a private key and a second key of the key pair is a public key. Data (e.g., a blockchain transaction, an authorization token, permissions data, a network transaction, control data for controlling a system, etc.) associated with the service may be encrypted using the public key. Providing access to the service may include decrypting the data using the private key.

FIG. 3 illustrates an architecture of a computing system 300 wherein the components of the system 300 are in electrical communication with each other using a connection 305, such as a bus. Exemplary system 300 includes a processing unit (CPU or processor) 310 and a system connection 305 that couples various system components including the system memory 315, such as read only memory (ROM) 320 and random access memory (RAM) 325, to the processor 310. The system 300 can include a cache of high-speed memory connected directly with, in close proximity to, or integrated as part of the processor 310. The system 300 can copy data from the memory 315 and/or the storage device 330 to the cache 312 for quick access by the processor 310. In this way, the cache can provide a performance boost that avoids processor 310 delays while waiting for data. These and other modules can control or be configured to control the processor 310 to perform various actions. Other system memory 315 may be available for use as well. The memory 315 can include multiple different types of memory with different performance characteristics. The processor 310 can include any general purpose processor and a hardware or software service, such as service 1 332, service 2 334, and service 3 336 stored in storage device 330, configured to control the processor 310 as well as a special-purpose processor where software instructions are incorporated into the actual processor design. The processor 310 may be a completely self-contained computing system, containing multiple cores or processors, a bus, memory controller, cache, etc. A multi-core processor may be symmetric or asymmetric.

To enable client interaction with the computing system 300, an input device 345 can represent any number of input mechanisms, such as a microphone for speech, a touch-sensitive screen for gesture or graphical input, keyboard, mouse, motion input, speech and so forth. An output device 335 can also be one or more of a number of output mechanisms known to those of skill in the art. In some instances, multimodal systems can enable a client to provide multiple types of input to communicate with the computing system 300. The communications interface 340 can generally govern and manage the client input and system output. There is no restriction on operating on any particular hardware arrangement and therefore the basic features here may easily be substituted for improved hardware or firmware arrangements as they are developed.

Storage device 330 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 325, read only memory (ROM) 320, and hybrids thereof.

The storage device 330 can include services 332, 334, 336 for controlling the processor 310. Other hardware or software modules are contemplated. The storage device 330 can be connected to the system connection 305. In one aspect, a hardware module that performs a particular function can include the software component stored in a computer-readable medium in connection with the necessary hardware components, such as the processor 310, connection 305, output device 335, and so forth, to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the concepts in this disclosure may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“ ”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” or “one or more of” a set indicates that one member of the set or multiple members of the set satisfy the claim. For example, claim language reciting “at least one of A and B” means A, B, or A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules.
Aspect 1. A method for access control, comprising: receiving, from at least two entities, at least two key sections associated with a first key of a key pair; generating the first key of the key pair based on the at least two key sections; and outputting the first key to provide access to a service.
Aspect 2. The method of Aspect 1, wherein: a first key section of the at least two key sections is received from a first entity of the at least two entities; and a second key section of the at least two key sections is received from a second entity of the at least two entities through the first entity.
Aspect 3. The method of any one of Aspects 1 or 2, wherein the at least two key sections are generated via at least two key cards, respectively.
Aspect 4. The method of Aspect 3, wherein the at least two key cards include at least two near-field communication (NFC) cards.
Aspect 5. The method of any one of Aspects 1 to 4, wherein: the first key is a private key; and a second key of the key pair is a public key.
Aspect 6. The method of Aspect 5, wherein data associated with the service is encrypted using the public key, and wherein providing access to the service includes decrypting the data using the private key.
Aspect 7. The method of Aspect 6, wherein the data is a blockchain transaction, an authorization token, or permissions data.
Aspect 8. The method of any one of Aspects 1 to 7, further comprising generating, using an application on a mobile device, a group including the at least two entities, wherein the at least two key sections are generated in response to the group being generated.
Aspect 9. An apparatus for access control, comprising: one or more memory; and one or more processors coupled to the one or more memory, the one or more processors configured to: receive, from at least two entities, at least two key sections associated with a first key of a key pair; generate the first key of the key pair based on the at least two key sections; and output the first key to provide access to a service.
Aspect 10. The apparatus of Aspect 9, wherein: a first key section of the at least two key sections is received from a first entity of the at least two entities; and a second key section of the at least two key sections is received from a second entity of the at least two entities through the first entity.
Aspect 11. The apparatus of any one of Aspects 9 or 10, wherein the at least two key sections are generated via at least two key cards, respectively.
Aspect 12. The apparatus of Aspect 11, wherein the at least two key cards include at least two near-field communication (NFC) cards.
Aspect 13. The apparatus of any one of Aspects 9 to 12, wherein: the first key is a private key; and a second key of the key pair is a public key.
Aspect 14. The apparatus of Aspect 13, wherein data associated with the service is encrypted using the public key, and wherein providing access to the service includes decrypting the data using the private key.
Aspect 15. The apparatus of Aspect 14, wherein the data is a blockchain transaction, an authorization token, or permissions data.
Aspect 16. The apparatus of any one of Aspects 9 to 15, wherein the one or more processors are configured to generate, using an application on a mobile device, a group including the at least two entities, wherein the at least two key sections are generated in response to the group being generated.
Aspect 17. A non-transitory computer-readable medium having stored thereon instructions that, when executed by one or more processors, cause the one or more processors to: receive, from at least two entities, at least two key sections associated with a first key of a key pair; generate the first key of the key pair based on the at least two key sections; and output the first key to provide access to a service.
Aspect 18. The non-transitory computer-readable medium of Aspect 17, wherein: a first key section of the at least two key sections is received from a first entity of the at least two entities; and a second key section of the at least two key sections is received from a second entity of the at least two entities through the first entity.
Aspect 19. The non-transitory computer-readable medium of any one of Aspects 17 or 18, wherein the at least two key sections are generated via at least two key cards, respectively.
Aspect 20. The non-transitory computer-readable medium of Aspect 19, wherein the at least two key cards include at least two near-field communication (NFC) cards.
Aspect 21. The non-transitory computer-readable medium of any one of Aspects 17 to 20, wherein: the first key is a private key; and a second key of the key pair is a public key.
Aspect 22. The non-transitory computer-readable medium of Aspect 21, wherein data associated with the service is encrypted using the public key, and wherein providing access to the service includes decrypting the data using the private key.
Aspect 23. The non-transitory computer-readable medium of Aspect 22, wherein the data is a blockchain transaction, an authorization token, or permissions data.
Aspect 24. The non-transitory computer-readable medium of any one of Aspects 17 to 23, further comprising instructions that, when executed by the one or more processors, cause the one or more processors to generate, using an application on a mobile device, a group including the at least two entities, wherein the at least two key sections are generated in response to the group being generated.

1. A method for access control, comprising:
receiving, from a first entity, a first key section, wherein the first key section is associated with a private key of a asymmetric key pair, wherein the first key section is generated in response to generating a group including the first entity and a second entity;
receiving, from a second entity, a second key section, wherein the second key section is associated with the private key of the asymmetric key pair wherein the second key section is generated in response to generating the group;
generating the private key of the asymmetric key pair based on the first key section and the second key section; and
using the private key to provide access to a service.

2. (canceled)

3. The method of claim 1, wherein:
the first key sections is generated via a first key card; and
the second key section is generated via a second key card.

4. The method of claim 3, wherein:
the first key cards comprises a first near-field communication (NFC) cards and
the second key card comprises a second NFC card.

5. The method of claim 1, wherein a second key of the asymmetric key pair is a public key.

6. The method of claim 5, wherein data associated with the service is encrypted using the public key, and wherein providing access to the service includes decrypting the data using the private key.

7. The method of claim 6, wherein the data is a blockchain transaction, an authorization token, or permissions data.

8. The method of claim 1, further comprising generating, using an application on a mobile device, the group including the first entity and a second entity.

9. An apparatus for access control, comprising:
one or more memories; and
one or more processors coupled to the one or more memories, the one or more processors configured to:
receive, from a first entity, a first key section, wherein the first key section is associated with a private key of a asymmetric key pair, wherein the first key section is generated in response to generating a group including the first entity and a second entity;
receive, from a second entity, a second key section, wherein the second key section is associated with the private key of the asymmetric key pair wherein the second key section is generated in response to generating the group;
generate the private key of the asymmetric key pair based on the first key section and the second key section; and
use the private key to provide access to a service.

10. (canceled)

11. The apparatus of claim 9, wherein:
the first key section is generated via a first key card; and
the second key section is generated via a second key card.

12. The apparatus of claim 11, wherein:
the first key card comprises a first near-field communication (NFC) card; and
the second key card comprises a second NFC card.

13. The apparatus of claim 9, wherein a second key of the asymmetric key pair is a public key.

14. The apparatus of claim 13, wherein data associated with the service is encrypted using the public key, and wherein providing access to the service includes decrypting the data using the private key.

15. The apparatus of claim 14, wherein the data is a blockchain transaction, an authorization token, or permissions data.

16. The apparatus of claim 9, wherein the one or more processors are configured to generate, using an application on a mobile device, the group including the first entity and a second entity.

17. A non-transitory computer-readable medium having stored thereon instructions that, when executed by one or more processors, cause the one or more processors to:
receive, from a first entity, a first key section, wherein the first key section is associated with a private key of a asymmetric key pair, wherein the first key section is generated in response to generating a group including the first entity and a second entity;
receive, from a second entity, a second key section, wherein the second key section is associated with the private key of the asymmetric key pair wherein the second key section is generated in response to generating the group;
generate the private key of the asymmetric key pair based on the first key section and the second key section; and
use the private key to provide access to a service.

18. (canceled)

19. The non-transitory computer-readable medium of claim 17,
wherein:
the first key section is generated via a first key card; and
the second key section is generated via a second key card.

20. The non-transitory computer-readable medium of claim 19, wherein:
the first key card comprises a first near-field communication (NFC) card; and
the second key card comprises a second NFC card.

21. (canceled)

22. The non-transitory computer-readable medium of claim 17, wherein data associated with the service is encrypted using a public key of the asymmetric key pair, and wherein providing access to the service includes decrypting the data using the private key.

23. The non-transitory computer-readable medium of claim 22, wherein the data is a blockchain transaction, an authorization token, or permissions data.

24. The non-transitory computer-readable medium of claim 17, further comprising instructions that, when executed by the one or more processors, cause the one or more processors to generate, using an application on a mobile device, the group including the first entity and a second entity.
